(19) United States
(12) Patent Application Publication
(10) Pub. No.: US 2019/0226562 A1
(43) Pub. Date: Jul. 25, 2019

(54) SPINDLE DRIVE

(71) Applicant: SCHAEFFLER TECHNOLOGIES AG & CO. KG, Herzogenaurach (DE)

(72) Inventors: Harald HOCHMUTH, Hagenbuechach (DE); Hartmut KREHMER, Erlangen (DE)

(73) Assignee: SCHAEFFLER TECHNOLOGIES AG & CO. KG, Herzogenaurach (DE)

(21) Appl. No.: 16/316,490

(22) PCT Filed: Jun. 20, 2017
(86) PCT No.: PCT/DE2017/100517

§ 371 Date: Jan. 9, 2019

(30) Foreign Application Priority Data
Jul. 22, 2016 (DE) 10 2016 213 425.6

(51) Int. Cl. F16H 25/24; F16C 29/02; F16C 19/30

(52) U.S. Cl. CPC F16H 25/24; F16H 25/2204; F16C 19/30; F16C 29/02

(57) ABSTRACT

A spindle drive includes a spindle nut, wherein the spindle nut is rotatably supported in a housing, a spindle, wherein the spindle is configured to be displaced in relation to the housing, an axial rolling bearing configured to support the spindle nut, wherein the axial rolling bearing does not guide axially, and a sliding bearing configured to support the spindle and act in a radial direction.

### CROSS-REFERENCE TO RELATED APPLICATIONS

This application is the U.S. National Phase of PCT/DE2017/100517 filed Jun. 20, 2017, which claims priority to DE 102016213425.6 filed Jul. 22, 2016, the entire disclosures of which are incorporated by reference herein.

### TECHNICAL FIELD

The disclosure relates to a spindle drive configured in particular for a device for height adjustment of a vehicle body.

### BACKGROUND

Various devices are known for height adjustment of a vehicle body, e.g. from DE 10 2014 215 420 A1and DE 10 2009 058 026 A1. Each of these known devices functions with one or more spindle drives for adjusting spring plates.

Another height adjustment device for wheel suspensions of motor vehicles is disclosed in DE 10 2007 004 747 B4, by way of example. This height adjustment device comprises numerous tapered seat ball bearings, also referred to as angular-contact bearings. With assemblies comprising numerous angular-contact bearings, both radial and axial forces can be accommodated.

The object of the disclosure is to further develop a spindle drive for an adjustable chassis that is more robust with respect to the prior art, and at the same time production-friendly and more compact.

### SUMMARY

This problem is solved according to the disclosure by a spindle drive with the features described below. The spindle drive has a housing in which a spindle nut and—at least in part—a spindle that interacts therewith, are located. The spindle nut is rotatably supported in the housing, while the spindle can be displaced in relation to the housing. Two axial rolling bearings support the spindle nut. These bearings act exclusively in the axial direction, i.e. bearings that do not guide axially. The spindle is supported by two sliding bearings that only act in the radial direction. The radial guidance of the spindle nut is obtained exclusively through the interaction of the spindle nut with the spindle. By separating the bearing functions, and only supporting the spindle nut radially by means of the spindle, redundant dimensioning is avoided that could have a negative effect on the function of the spindle drive. This plays a role in particular with regard to the aspect of production tolerances, in particular in mass production, as well as load dependent geometric modifications.

The spindle nut may interact with the spindle in one configuration in the form of a ball screw drive. This can basically comprise a ball screw drive with or without a rolling element return. Instead of balls, other rolling elements, e.g. rollers, can also be used in the spindle drive. In any case, the rolling elements between the spindle nut and the spindle serve a double function.

First, the rotation of the spindle nut is converted by these rolling elements into a linear movement of the spindle, i.e. the threaded spindle. Second, the spindle nut is also supported radially on the spindle by the same rolling elements. The radial position of the spindle nut in relation to the housing is thus determined by a combination of sequential bearings, specifically the two parallel radial sliding bearings that support the spindle in the housing. Viewed axially along the spindle drive, the two radial sliding bearings are located in front of or behind the spindle nut, together with their axial bearing. Another radial bearing located downstream of the assembly comprising the two radial sliding bearings, forms the bearing, in particular a ball bearing, for the spindle nut on the spindle, which also converts the rotation of the spindle nut into the displacement of the spindle. There is no further radial bearing for the spindle nut.

The rolling elements of the two axial roller bearings that support the spindle nut axially, can roll either directly on the spindle nut or on separate disk-shaped components connected to the spindle nut. The rolling elements of the axial roller bearing may not come in contact with the housing in one embodiment. Instead, bearing disks may be placed in the housing, on which the rolling elements roll. Embodiments in which the rolling elements of the axial roller bearing roll directly on the surface of the housing are also possible.

The housing may have steps that radially secure the bearing disks retained on the housing. The rolling elements of each axial roller bearing can be guided in each case by a bearing cage. The axial roller bearing can be a fully complementary rolling bearing. The axial roller bearings may be roller bearings or needle bearings. In theory, the function of at least one axial roller bearing can be assumed by a sliding bearing in a modified construction.

Various bearing variations can be used for the sliding bearing of the spindle in the housing: in the simplest case, the substantially cylindrical surface of the housing, which has at least one threading, is in direct contact with an inner wall of the housing. A separate sliding bearing element that does not interact directly with the spindle nut, can form a component of the sliding bearing as part of the spindle or a component connected to the spindle. It can be ensured in a simple manner with this separate sliding bearing element that there is always an annular gap between the outer circumference of the threaded section of the spindle and the wall of the housing. In any case, the spindle can have a single thread or multiple threads.

According to an embodiment of the spindle drive, which is configured in particular for use in a device for adjusting the height of a motor vehicle, the spindle nut also forms a pulley for a belt. The spindle nut can likewise be connected to a separate pulley for conjoint rotation therewith. Alternatively, the spindle nut can be driven directly, without a drive, or via a gear mechanism. In the latter case, the spindle nut either forms an output gear of a gear mechanism, or is connected thereto for conjoint rotation. The spindle nut may be driven electrically. In theory, another drive, e.g. hydraulic or pneumatic, is also possible.

As a result of the belt drive for the spindle nut, there are two different types of successive gear mechanisms, specifically the pulley drive and a threaded drive. A drive pulley, via which the spindle nut is driven, may use an electric motor, is located inside the housing of the spindle drive in one embodiment. The same applies for a drive gear, via which the spindle nut can be driven.

The advantage of the disclosure is in particular that axial and radial bearing functions inside the spindle drive are entirely separated from one another, wherein the spindle nut is supported exclusively by the spindle in the radial direction. As a result, a floating bearing of the spindle nut is obtained in the housing.

### BRIEF DESCRIPTION OF THE DRAWINGS

Two exemplary embodiments of the disclosure shall be explained in greater detail below on the basis of the drawings. Therein:

FIG. 1 shows a spindle drive in a sectional view,

FIG. 2 shows a detail of an alternative design for a spindle drive.

### DETAILED DESCRIPTION

The following explanations relate to both exemplary embodiments unless otherwise specified.

A spindle drive, indicated as a whole by the reference numeral 1, is used to adjust the height of a motor vehicle. Reference is made to the prior art cited in the introduction regarding the principle function of the spindle drive 1.

The spindle drive 1 is configured as a ball screw drive, wherein rolling elements 4, specifically balls, roll between a spindle 2 and a dedicated spindle nut 3. A ball return is not shown in the figures. The spindle 2 has a ball groove 5, describing a single threading. In this manner, rotation of the spindle nut 3 is converted to a linear displacement of the spindle along the central axis M. A twisting safeguard for the spindle 2 in a housing 6 is not shown.

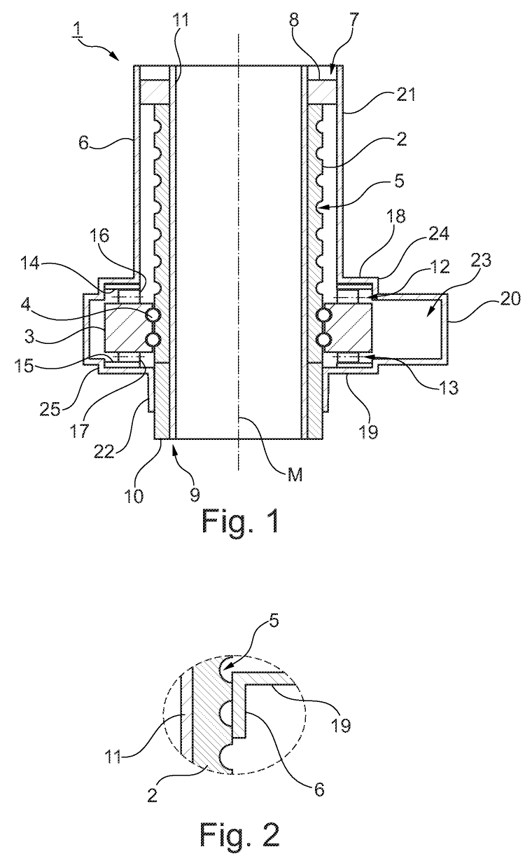

There are two sliding bearings 7, 9, i.e. radial sliding bearings, for the radial bearing of the spindle 2 in the housing 6, which each have a sliding bearing element 8, 10 in the embodiment shown in FIG. 1. The embodiment shown in FIG. 2 differs therefrom in that it does not have the sliding bearing element 10 in the embodiment in FIG. 1. The embodiment according to FIG. 2 is thus a simplified variation of the spindle drive 1, in which there is also a double sliding bearing of the spindle 2 in the housing 6. In another, further simplified embodiment, not shown herein, the sliding element 8 located at the top in FIG. 1 can also be omitted, both in the embodiment according to FIG. 2 as well as in the embodiment according to FIG. 1. The hollow spindle 2 has an inner tube 11 in all of the embodiments.

In contrast to the spindle 2, which is only supported radially in the housing 6, the spindle nut 3 is only supported in both axial directions in relation to the housing 6. There are two axial bearings 12, 13 for this, specifically axially roller bearings, each of which has a bearing disk 14, 15 and numerous rollers 16, 17 serving as rolling elements. Each bearing disk 14, 15 is placed on an annular disk section 18, 19 of the housing 6. Each bearing disk 14, 15 is secured radially by a cylindrical step 24, 25 of the housing in the present case. The annular disk sections 18, 19 and the cylindrical steps 24, 25 are structures of an extension of the housing 6 indicated as a whole with the numeral 20.

The housing extension 20 extends asymmetrically in the radial direction via cylindrical tube sections 21, 22 of the housing 6, which are located axially in front of or behind the spindle nut 3. As a result, an extension space 23 is created inside the housing extension 20, which can accommodate a pulley, not shown. A drive belt wraps around this pulley and the spindle nut 3, by means of which the spindle nut 3 can be driven using a belt drive.

Radial forces acting on the spindle nut 3 are applied to the rolling elements 4, which support the spindle nut 3 on the spindle 2, and also convert the rotation of the spindle nut 3 into the displacement of the spindle 2. The spindle nut 3 is supported in a floating manner in the housing 6 of the spindle drive 1 by the axial roller bearings 12, 13. Radial forces acting on the spindle nut 3 have no effect on the force acting within the axial roller bearings 12, 13, in contrast to bearing assemblies that have angular-contact bearings.

### LIST OF REFERENCE SYMBOLS

1 spindle drive
2 spindle
3 spindle nut
4 rolling element, ball
5 ball groove
6 housing
7 radial sliding bearing
8 sliding bearing element
9 radial sliding bearing
10 sliding bearing element
11 inner tube
12 axial roller bearing
13 axial roller bearing
14 bearing disk
15 bearing disk
16 rolling element, roller
17 rolling element, roller
18 annular disk section
19 annular disk section
20 housing extension
21 tube section
22 tube section
23 extension space
24 step
25 step
M central axis

1. A spindle drive comprising:
a spindle nut configured to be rotated in a housing; and
a spindle that interacts with the spindle nut, wherein the spindle nut is supported in the housing by two axial roller bearings and the spindle is supported in the housing by two radial sliding bearings.

2. The spindle drive of claim 1, wherein rolling elements in the axial roller bearings roll on one side along the spindle nut and on the other side along bearing disks placed in the housing.

3. The spindle drive of claim 2, wherein the bearing disks are secured radially in the housing by steps formed therein.

4. The spindle drive of claim 1, wherein the axial roller bearings are roller bearings or needle bearings.

5. The spindle drive of claim 1, wherein at least one radial sliding bearing is formed directly between the spindle and the housing.

6. The spindle drive of claim 1, wherein at least one radial sliding bearing is formed between a sliding bearing element connected to the spindle and the housing.

7. The spindle drive of claim 1, wherein rolling elements are provided between the spindle and the spindle nut and provided solely for radial support of the spindle nut on the spindle.

8. The spindle drive of claim 1, wherein the spindle nut is designed as a pulley.

9. The spindle drive of claim 1, wherein the spindle nut is an output drive gear.

10. (canceled)

11. A spindle drive, comprising:
a spindle nut rotatably supported in a housing;
a spindle is configured to be displaced in relation to the housing;
an axial rolling bearing configured to support the spindle nut, wherein the axial rolling bearing does not guide axially; and
a sliding bearing configured to support the spindle and act in a radial direction.

12. The spindle drive of claim 11, wherein the spindle drive is configured as a ball screw drive that includes a plurality of rolling elements configured to roll between the spindle and the spindle nut.

13. The spindle drive of claim 11, wherein radial forces acting on the spindle nut are applied to the plurality of rolling elements and convert rotation of the spindle nut into the displacement of the spindle.

14. The spindle drive of claim 11, wherein the sliding bearing includes a sliding bearing element.

15. The spindle drive of claim 11, wherein the axial rolling bearing includes a bearing disk and a plurality of rollers.

16. The spindle drive of claim 15, wherein the bearing disk is located on an annular disk section of the housing.

17. The spindle drive of claim 16, wherein the bearing disk is secured radially by a cylindrical step of the housing.

18. The spindle drive of claim 17, wherein the annular disk section and the cylindrical step are an extension of the housing.

19. The spindle drive of claim 18, wherein the extension extends asymmetrically in a radial direction via cylindrical tube sections of the housing, wherein the cylindrical tube sections are located axially in front or behind the spindle nut.

20. A spindle drive, comprising:
a spindle nut, wherein the spindle nut is rotatably supported in a housing;
a spindle, wherein the spindle is configured to be displaced in relation to the housing;
a plurality of axial rolling bearings configured to support the spindle nut, wherein the axial rolling bearing does not guide axially; and
a plurality of sliding bearings configured to support the spindle.
